(19) United States
(12) Patent Application Publication
(10) Pub. No.: US 2006/0162821 A1
(43) Pub. Date: Jul. 27, 2006

(54) Method for the production of an anisotropic magnetic powder and a bonded anisotropic magnet produced therefrom

(76) Inventor: Georg Werner Reppel, Hammersbach (DE)

Correspondence Address: JOHN S. PRATT, ESQ;KILPATRICK STOCKTON, LLP, 1100 PEACHTREE STREET, ATLANTA, GA, 30309, US

(21) Appl. No.: 10/524,752

(22) PCT Filed: Nov. 27, 2003
(86) PCT No.: PCT/EP03/13383

§ 371 Date: Jul. 7, 2005

(30) Foreign Application Priority Data
Nov. 28, 2002 (DE) 102 55 604.0

(51) Int. Cl. H01F 41/00

(52) U.S. Cl. 148/300; 75/348

(57) ABSTRACT

The invention relates to a method for the production of an anisotropic magnetic powder or a magnet produced from said powder, wherein a hydrogenating and dehydrogenating method is applied to the starting material in order to produce the powder. An anisotropic oriented magnetic material, more particularly magnetic scrap metal is advantageously used as starting material so that the complicated use of a molten mass with isotropic distribution of the c axes of the hard metal crystals is not required.

This invention relates to a method for producing anisotropic magnetic powder having the features of the preamble of Patent Claim 1 and/or a bonded anisotropic magnet produced from such a powder.

In the production of Nd—Fe—B sintered magnets, sintered magnetic residues, also known as magnetic scrap metal, are formed. This magnetic scrap metal is composed, for example, of end pieces of crude magnets, e.g., compression molded or isostatically pressed parts or blocks, parts that have been improperly coated or are useless either magnetically or because of their dimensions as well as excess quantities. This magnetic scrap metal has a relatively high metal value. However, reusing it for production of magnets poses problems and/or is expensive because in this state this material contains impurities, e.g., Ni, C, O which interfere with recycling. Current recycling options consist of using the magnetic scrap material in a new melt, where it is cut with newly weighed-in material. Furthermore it is possible to grind the magnetic scrap metal, remove most of the Ni impurities and process it in a mixture with another newly produced powder having a suitable composition to form sintered magnets. Ultimately, regeneration by direct reduction with calcium is also known. These recycling methods for production of new sintered magnets result in sacrifices in terms of the magnet quality or high costs. Because of these problems in recycling, large quantities of magnetic scrap metal have already accumulated.

For the production of plastic-bonded magnets, impurities due to the use of magnetic metal scrap would be virtually irrelevant because they would constitute only an insignificant dilution based on their volume. However, if the magnetic scrap metal is to be bonded and the powder is to be processed to bonded magnets, then there is the problem that the coercitive field strength (Hc) decreases greatly during milling if the material does not already have an Hc deficiency. Due to the placement of the magnetic powder in air, the surface and thus the magnetic properties are further damaged by nucleation. Consequently such magnets would not be stable even when used at moderate temperatures or with weak opposing fields.

To produce high-quality anisotropically-bonded magnets based on Nd—Fe—B, German Patent DE 199 50 835 A1 (Aichi Steel) has disclosed a so-called HDDR method. In this method, powder with a good anisotropy and coercitive field strength is manufactured from a lumpy Nd—Fe—B melt having an isotropic distribution of the c axes of the hard magnetic crystals by hydrogenation and dehydrogenation in a special process. For this process, a homogeneous melt which may contain hardly any α-Fe and free Nd must thus be used. In addition, a material with coarse columnar crystals should be used. This method is thus extremely complex and expensive accordingly.

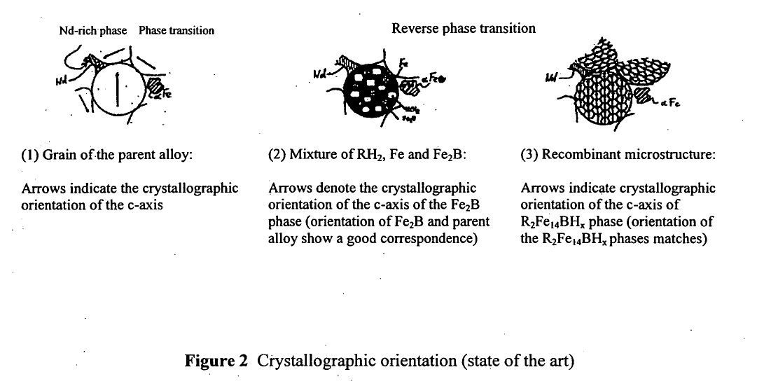

As shown in FIG. 2 which illustrates the crystallographic orientation of crystals in the HDDR process, problems occur due to the use of a cast block of an alloy based on NdFeB as the starting material. As shown by the figure on the left, a grain of a parent alloy which corresponds to a crystal has a crystallographic orientation of the c-axis. This orientation is usually different from the orientations of neighboring grains, i.e., there is a random distribution of the orientation of the c axes. The grains in the melt are also relatively coarse. In addition there is the problem of inhomogeneity due to coarse α-Fe and Nd-rich precipitation and deposition.

In the reverse phase transition, which is diagrammed in the middle drawing and/or the drawing on the right, a mixture of RH₂, Fe and Fe₂B is formed from R₂Fe₁₄B, where R stands for a rare earth element. The reactions are explained by the fact that the crystallographic orientation of the c-axis of the Fe₂B phase does not change, i.e., the orientation of Fe₂B matches that of the grain of the parent alloy. Ultimately, a recombined microstructure is obtained, where the arrows denote the crystallographic orientation of the c-axis of the R₂Fe₁₄BHₓ phase. This phase orientation again corresponds to that of the phase of the parent alloy of the grain.

A similar process for production of anisotropic R-T-B magnetic powder which is also based on hydrogenation and dehydrogenation (HDDR) of fused alloys and its use for bonded magnets are described in German Patent DE 693 15 807.

One problem in the technical implementation of the HDDR method according to the state of the art is the influence of numerous parameters such as temperature, hydrogen pressure, etc., on the one hand, but on the other hand the composition and microstructure of the starting material (melt) also play an important role. This is expressed in a different anisotropy of the resulting melt, which may be manifested, e.g., as the ratio of remanence and saturation polarization, for example. A ratio approaching one is desired but is never achieved in practice.

The object of this invention is to propose an improved method for producing an anisotropic magnetic powder and/or a bonded magnet from such a powder.

This object is achieved by the method for producing an anisotropic powder having the features of Patent Claim 1 and/or 2 and/or by a bonded magnet from a powder produced in this way having the features of Patent Claim 18.

Advantageous embodiments are the object of the dependent claims.

A method for producing an anisotropic magnetic powder using the HDDR method which is known per se is advantageous, but instead of using a melt with an isotropic distribution of the c axes of the hard magnetic crystals as the starting material, a magnetic material with anisotropy is used, i.e., the crystals are already oriented. It is thus possible to use magnetic scrap metal as the starting material.

The starting material should expediently be crystals that are already oriented and have a fine crystal size and a more homogeneous distribution of foreign phases, e.g., oxides, α-Fe, Nd-rich phases, borides. With the known HDDR method, large grains and coarse deposition of unwanted foreign phases such as free iron or phases with a high rare earth content, often in the range of several mm, must be accepted, but with the method described here, a starting material with an average particle size of less than 1 mm, a hard magnetic volume content of greater than 90% and foreign phases less than 0.5 mm in size are used. Magnetic scrap metal in particular is a starting material that is easy to process for use accordingly and meets these conditions. Using the essentially known hydrogenation and dehydrogenation and/or desorption processes on such a starting material ultimately makes available a powder which preferably has particles smaller than 0.5 mm in size. Advantageously a bonded magnet can be produced from this powder in an orienting magnetic field, offering an energy product BHmax of more than 10 MGOe (80 kJ/m³), for example.

The magnet material is advantageously a permanent magnet material with a hard magnetic phase SE₂TM₁₄B where SE stands for a rare earth element including Y and TM stands for a transition metal, e.g., Fe, Co or Ni. In addition, additives such as Si, Zr, Tb, Ga, Al, etc. including unavoidable amounts of C, O, N and S may also be present. In particular when using the powder for producing a plastic or metal bonded magnet, such additives cause little or no disadvantage.

The starting material should expediently consist of a lumpy material or a powder in which the crystal size amounts to at most 75% of the particle size. To do so, the starting material may be ground before the hydrogenation/dehydrogenation treatment and sorted by screening or fractionation and separated from foreign phase components. The starting material is expediently first collected separately according to magnet qualities (Hc) and cleaned to minimize impurities due to degreasing, pyrolysis, separation, etc. In addition, cleaning of the material surfaces may be accomplished by annealing the starting material in vacuo, under a noble gas or hydrogen. For example, desorption, deoxidation or decarburization reactions may be used.

After the hydrogenation/dehydrogenation treatment, a heat treatment is advantageously performed at a temperature of less than 600° C. under noble gas atmosphere or a vacuum atmosphere. This treatment reduces any traces of hydrogen that might still be present in the material and eliminates disturbances in the particle surface so that the stability of the powder and/or the magnet produced from it is/are increased. This is manifested in lower irreversible losses of the bonded magnets at elevated temperatures.

Preferably the material is ground to the desired particle size after the HDDR treatment or after the subsequent heat treatment, with an average particle size between 5 and 400 μm being advantageous. The powder ultimately achieved is advantageously tested in smaller batches and then homogenized by blending various powders. In particular, screening is advantageous to eliminate powder components larger than 0.5 mm in size.

It has been found, however, that this coarse fraction can be used after further size reduction and screening without any negative effect on the magnetic properties. This increase in yield is an essential advantage of the method according to this invention. With the traditional HDDR method using a melt as the starting material, precipitation products rich in iron and Nd can hardly be avoided; some can be separated through the coarse fraction after the treatment but are useless. The coarse fraction of the traditional material thus has definitely inferior properties in comparison with that according to the present invention.

To counteract this disadvantage, an attempt is made in the traditional method to improve the molten starting material in an additional homogenization annealing step by distributing the coarse foreign phase fractions more uniformly and refining them. Experience has shown that this can be accomplished only incompletely so that the advantages of the inventive process that does not require this homogenization treatment at a high temperature and the more uniform and powder quality which is essentially independent of particle size are preserved.

It is also advantageous to limit the particle size fraction smaller than 32 μm in size to max. 10% because this fine fraction may have a lower coercitive field strength than the remaining material.

The powder may then be coated to prevent corrosion effects and the like. For example, organic antioxidants or metallic layers have a positive effect. The coating also reduces the irreversible losses at an elevated temperature and improves the corrosion resistance.

Ultimately, bonded magnets that have a degree of orientation of more than 70% (anisotropy ratio >0.7) in an advantageous embodiment are produced from this powder. The degree of filling of magnetic fractions and/or particles in such a bonded magnet may amount to 63 vol % or more in an especially preferred embodiment. In this discussion, the grain size is understood to refer to the crystal size and not the particle size. Foreign phases include all phase components whose magnetic properties (Br, HcJ) advantageously turn out to be less favorable by more than 50% than is the case with the hard magnetic phase. Magnetic scrap metal is generally understood to include magnetic metals and magnets that cannot be used for various reasons. For example, magnetic scrap metal may consist of parts that are magnetically or visually inadequate or improperly coated or having incorrect dimension.

A bonded magnet is understood to be a magnet produced by bonding a powder containing the hard magnetic phase in a plastic or metal matrix. The degree of filling refers in general to the percentage volume amount (%) of the metal powder in the total volume of the magnet.

An exemplary embodiment will now be explained in greater detail on the basis of the drawing, in which:

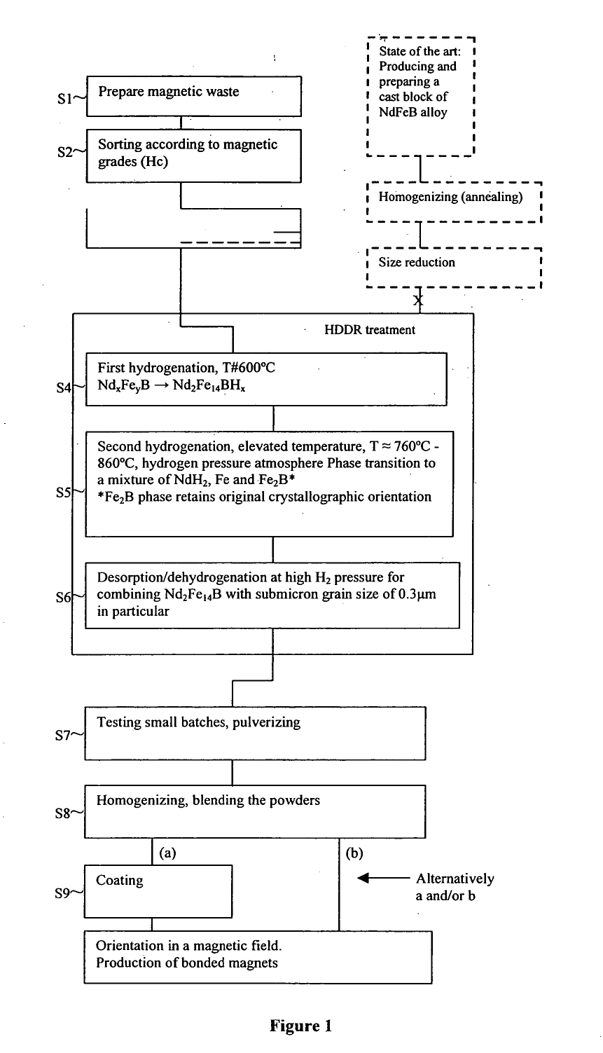

FIG. 1 shows a flow chart for the process steps for producing an anisotropic magnetic powder and

FIG. 2 shows the crystallographic orientation in a grain during and after the use of the HDDR method which is known per se and

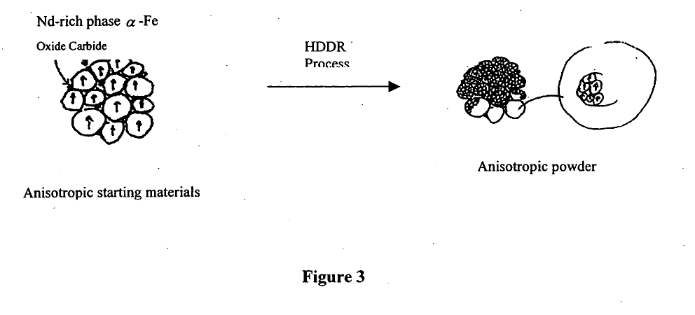

FIG. 3 shows the crystallographic orientation of the inventive starting material before, during and after the use of the essentially known HDDR method.

As shown in FIG. 1, magnetic materials having anisotropy, i.e., already oriented crystals and a largely homogeneous fine-grained structure, are used as the starting material. Thus magnetic waste and/or scrap magnetic metal may be used as the starting material to advantage (step S1).

The magnetic material has crystals that are already oriented, whereby the crystal size should be finer than in the case of using a cast block of an alloy based on NdFeB according to the known HDDR method. Due to the selected starting material, this usually also yields a more homogeneous distribution of the foreign phases (e.g., oxides, α-Fe, Nd-rich phase, boride), so the HDDR method can be used to particular advantage. SE₂TM₁₄B is advantageously used as the starting material, where SE stands for a rare earth element, including Y, and TM stands for a transition metal including Fe, Co, Ni, etc. Additives such as Si, Zr, Y, Tb, Ga, Al, Nb, Hf, W, V, Mo, Ti, etc. are also possible, including unavoidable amounts of C, O, N and S, as is general knowledge.

The starting material is advantageously sorted, in particular sorted according to magnetic qualities and magnetic materials (step S2). This yields a particularly narrow distribution of the coercitive field strengths of the particles.

The individual sorted batches are expediently cleaned subsequently, in particular by degreasing, pyrolyzing and separating them. Then the starting material is ground to the desired powder particle size, in particular to powder with particles smaller than 0.5 mm in size (step S3). Cleaning by annealing in vacuo, in noble gas or hydrogen removes oxygen and carbon, in particular from the surface of the starting material.

It is also advantageous to separate unwanted impurities such as layer residues, dust, etc., e.g., by screening.

The HDDR method, which is known per se from German Patent DE 199 50 835 A1, is described below with reference to the full content of the description there (steps S4 through S6).

In the HDDR treatment, in a first step, hydrogenation is performed on the starting material, e.g., an alloy based on NdFeB at a low temperature (step S4). The alloy based on NdFeB absorbs hydrogen under a high hydrogen pressure and below a temperature of 600° C. in particular so that it becomes hydride of Nd₂Fe₁₄BHₓ which stores enough hydrogen to induce a disproportionation reaction. Then the hydride is subjected to a second hydrogenation at an elevated temperature (step S5). In this process, the hydride is heated to a temperature of 760° C. to 860° C. for the disproportionation reaction under a suitable hydrogen pressure which supplies the hydrogen required for the disproportionation reaction after consumption of the stored hydrogen. Therefore a uniform phase transition takes place at a suitable reaction rate, producing a mixture of NdH₂, Fe and Fe₂B. The Fe₂B phase is formed to such an extent that it has the original crystallographic orientation and is transferred to the newly formed Nd₂Fe₁₄B grains in recombination (step S6). The crystallographic orientation is illustrated in the diagrams in FIG. 2. It can be seen that the crystallographic orientation of the Fe₂B phase and the crystallographic orientation of the Nd₂Fe₁₄B matrix phase match.

In another step (S6) a dehydrogenation or desorption process is performed for recombination of the mixture, where NdFeB with a submicron grain size of preferably approximately 0.3 μm is formed.

Since the powder particles produced by this process contain a multitude of submicron grains, a very good anisotropy of these grains is crucial for the anisotropy of the magnet produced from the powder.

By using the magnetic material which is already anisotropic as the starting material, the development of the anisotropy of the powder produced according to this invention is even better. An important reason for this is that in size reduction of the material treated with HDDR, transition zones with a different orientation are prevented. This is explained further below and is illustrated in FIGS. 2 and 3.

Starting with the finer grains of the anisotropic starting material with an average grain size of <1 mm, preferably <0.1 mm, even smaller submicron grain sizes are advantageously formed. In a first desorption step, the reverse phase transition takes place as uniformly as possible by keeping the hydrogen pressure so high that the desorption reaction can be maintained. The recombined Nd₂Fe₁₄B matrix grows by retaining its crystallographic orientation in agreement with the crystallographic orientation of the Fe₂B phase. In this process, the alloy again becomes a hydride of Nd₂Fe₁₄BHₓ because a large amount of hydrogen is still present in the alloy. Therefore the hydrogen is then dehydrogenated or desorbed as completely as possible out of the alloy under a high vacuum.

The recombined Nd₂Fe₁₄B matrix in agreement with the original crystallographic orientation has a high degree of orientation with the crystallographic grain orientation so that a high anisotropy is imparted to the magnet and/or magnetic powder. At the same time, the phase has a fine and uniformly granular microstructure which yields a high coercitive force Hc.

FIG. 3 shows the anisotropic starting material before and after the HDDR treatment. In comparison with FIG. 3, it is clear here that the direction of the fracture face in size reduction of the treated material is irrelevant. In the traditional process, however, it is unavoidable that the fracture runs through regions with a different orientation on the whole. As a result of this, many powder particles in the internal regions have different orientations. After aligning these particles in a magnetic field to produce an anisotropic magnet, this disordered orientation is of course retained.

In the process according to this invention, regions of different orientation are not formed, so an even higher degree of anisotropy of the powder (preferably more than 0.8) is achieved.

The anisotropic magnetic powder produced in this way has excellent magnetic properties and may be used to produce, for example, bonded magnets or sintered magnets.

In another process step (S7) after the HDDR treatment, a test is advantageously performed on smaller batches. If needed, another pulverization step is also performed. Frequently also a homogenization operation by blending powders having different properties from different batches is also advantageous (step S8). This powder can then be used for producing bonded magnets in an orienting magnetic field (step S10). Before production of the bonded magnet or a sintered magnet (step S10), it is also possible to coat the powder (step S9).

The magnetic powder produced in this way is preferably freed of coarse fractions larger than 0.5 mm in size in the steps after the HDDR treatment. Magnetic powder with a particle size fraction of max. 10% <32 μm in size is preferred. A renewed heat treatment up to 600° C. or lower in a noble gas atmosphere or a vacuum atmosphere is also advantageous.

With respect to the alloy, a variety of materials are available. One or more rare earth elements may be selected, for example, from the group consisting of yttrium (Y), lanthanum (La), cerium (Ce), praseodymium (Pr), neodymium (Nd), samarium (Sm), gadolinium (Gd), terbium (Tb), dysprosium (Dy), holmium (Ho), erbium (Er), thulium (Tm) and lutetium (Lu). Iron (Fe) and boron (B) with unavoidable impurities are usually also components of the powder. Neodymium (Nd) is especially preferred as the rare earth element. To improve the magnetic properties, other materials, e.g., Ga or niobium (Nb) may also be added. In particular, preferably one or more elements from the list including Al, Si, Ti, V, Cr, Mn, Ni, Cu, Ge, Zr, Mo, In, Sn, Hf, Ta, W and Pb should also be added to improve the coercitive force and the orthogonality of the demagnetization curve. The Curie temperature of the alloy can be raised by adding the element Co to improve the magnetic properties at elevated temperatures.

In particular a high-frequency oven or a smelting furnace may be used to perform the HDDR method such as that disclosed in German Patent DE 199 50 835 A1 for performing the HDDR method.

The production of bonded or sintered magnets may be performed in an essentially known way. For example, the magnetic powder produced may be mixed with a solid epoxy powder in a ratio of 3 wt % and then pressed in a mold using a press equipped with an electromagnet and a heating element at a high temperature in a magnetic field of 20 kOe (16 kA/cm), for example. Preferably, however, bonded magnets with an energy product BHmax of more than 10 MGOe (80 kJ/m³) is preferred.

Such a magnet advantageously has a degree of orientation of 70% (anisotropy ratio 0.7) or more. The degree of filling of magnetic components preferably amounts to at least 63 vol %.

1. Method for producing an anisotropic magnetic powder, in which
with a starting material based on an SE-TM-B alloy, where SE is a rare earth element including yttrium and TM is a transition metal,
a mixture having a TMₓB phase, in particular Fe₂B phase is produced by a first hydrogenation process with heating under a hydrogen pressure to produce a hybrid and by a second hydrogenation process to produce a phase transition which takes place under a hydrogen pressure and an elevated temperature that induces a phase transition,
a dehydrogenation process with a reverse phase transition (HDDR method) is performed,
wherein
a magnetic material with an anisotropic orientation is used as the starting material.

2. Method for producing an anisotropic magnetic powder, in which
with a starting material based on an SE-TM-B alloy, where SE is a rare earth element including yttrium and TM is a transition metal,
a mixture having a TMₓB phase, in particular an Fe₂B phase is produced by a first hydrogenation process with heating under a hydrogenation pressure to create a hybrid and by a second hydrogenation process to induce a phase transition which takes place under a hydrogenation pressure and at an elevated temperature which induces a phase transition and
a dehydrogenation process with a reverse phase transition (HDDR method) is performed,
whereby the starting as a magnetic material consists at least partially of magnetic scrap metal.

3. Method according to claim 1, in which a permanent magnetic material with a hard magnetic phase SE₂TM₁₄B is used as the magnetic material, where SE is a rare earth element including Y and TM is a transition metal.

4. Method according to claim 1, in which at least one of the elements Fe, Ni or Co is provided as the transition metal.

5. Method according to claim 1, in which additives including amounts of C, O, N and/or S are present.

6. Method according to claim 1, in which a magnetic material with an average grain size of less than 1 mm, a hard magnetic content greater than 90% by volume and/or foreign phases smaller than 0.5 mm in size is used as the starting material.

7. Method according to claim 1, in which a magnetic material with an average grain size smaller than 0.1 mm is used as the starting material.

8. Method according to claim 1, in which the starting material is ground and screened or fractionated before the hydrogenation/dehydrogenation treatment.

9. Method according to claim 1, in which a magnetic powder with a crystal size amounting to at most 75% of the particle size is selected as the starting material.

10. Method according to claim 1, in which the starting material is cleaned, especially removing foreign phase fractions.

11. Method according to claim 1, in which the starting material is cleaned by annealing in vacuo, in a noble gas or in hydrogen before the hydrogenation/dehydrogenation treatment.

12. Method according to claim 1, in which a heat treatment is performed in particular at a temperature up to 600° C. under a noble gas or a vacuum atmosphere after the hydrogenation/dehydrogenation treatment.

13. Method according to claim 1, in which the magnetic powder that is produced is homogenized by blending the powders.

14. Method according to claim 1, in which the magnetic powder produced is freed of a coarse fraction greater than 0.5 mm in size by screening.

15. Method according to claim 1, in which the magnetic powder is supplied with a particle fraction of max. 10% particles <32 μm in size.

16. Method according to claim 1, in which the magnetic powder is coated.

17. Method according to claim 1, wherein B is partially replaced by C.

18. Plastic or metal bonded magnet manufactured using a metal powder produced by a method according to claim 1.

19. Magnet according to claim 18, with an energy product BHmax greater than 80 kJ/m³.

20. Magnet according to claim 18, with a degree of orientation equal to or greater than 70%.

21. Magnet according to claim 18, with a degree of filling of magnetic fractions of at least 63 vol %.
